(19) United States
(12) Patent Application Publication
(10) Pub. No.: US 2006/0159856 A1
(43) Pub. Date: Jul. 20, 2006

(54) Method for forming reactive coatings

(76) Inventors: Martin Kunz, Efringen-Kirchen (DE); Michael Bauer, Forchheim (DE); Andreas Baranyai, Heitersheim (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/538,890

(22) PCT Filed: Dec. 15, 2003
(86) PCT No.: PCT/EP03/51010

§ 371 Date: Mar. 1, 2006

(30) Foreign Application Priority Data
Dec. 20, 2002 (DE) 102 60 336.7

(51) Int. Cl. B05D 3/00; B29C 71/04; B05D 1/36

(52) U.S. Cl. 427/402; 427/532

(57) ABSTRACT

The invention relates to a method for forming coatings on an inorganic or organic substrate and to substrates coated in accordance with the method. In the method: a) a low-temperature plasma, a corona discharge, high-energy radiation and/or a flame treatment is caused to act on the inorganic or organic substrate, b) 1.) at least one activatable initiator or 2.) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one group that interacts with a subsequently applied coating or reacts with groups contained therein, with the effect of promoting adhesion, and c) the coated substrate is heated and/or is irradiated with electromagnetic waves and an adhesion promoter layer is formed, d) the substrate so pretreated is provided with the further coating which contains reactive groups that react with those of the adhesion promoter layer and/or interact with the adhesion promoter layer.

The invention relates to a method for producing a reactive coating having good adhesion on organic or inorganic substrates.

Plasma processes have been used for the production of reactive coatings on surfaces for some time. Plasma polymerisation, in particular, is frequently used in this respect. For that purpose, polymerisable precursors are supplied to a low pressure plasma by way of the gas phase and are deposited on the surface in polymerised form. Techniques used for that purpose and the surfaces thereby obtained as well as their use are described, for example, in “Plasma Surface Modification and Plasma Polymerization” by N. Inagaki, Technomic Publishing Company Inc., Lancaster 1996, “Plasma Polymerization” by H. Yasuda, Academic Press Inc., New York 1985 and “Plasma Polymerization Processes” by H. Biederman, Y. Osada, Elsevier Science Publishers, Amsterdam 1992.

The plasma-assisted deposition of polymerisable compounds frequently results in unforeseeable modifications of the structures at the molecular level. Especially when reactive groups are present in the molecule, degradation reactions and other changes may occur. In plasma, reactive groups can readily be oxidised or split off. In addition, the molecules used can be totally destroyed by the short-wave radiation and high-energy species, such as ions and free radicals, present in the plasma. The deposited or polymerised film may therefore have much poorer properties or properties completely different from those of the compounds originally used. In order to retain the structure to the maximum degree, use is therefore increasingly being made of pulsed plasmas, in which a short plasma pulse for initiating the polymerisation is followed by a longer phase in which the plasma is switched off but the supply of polymerisable compounds is maintained. This results in a process having lower efficiency and even greater complexity, however. Such processes are described, for example, by G. Kuhn et al. in Surfaces and Coatings Technology 142, 2001, page 494. Furthermore, the mentioned plasma techniques need to be carried out in vacuo and accordingly require complex apparatus and time-consuming procedures. Moreover, the compounds (precursors) to be applied or polymerised have to be vaporised and recondensed on the substrate, which can lead to high levels of thermal stress and, in many cases, to decomposition. In addition, the vaporisation and deposition rates are low, with the result that the production of layers of adequate thickness is difficult and laborious.

A modified approach is described in WO 00/24527 and WO 01/58971 in which the plasma treatment and the production of layers are decoupled. This eliminates the problems caused by the action of the low pressure plasma on the precursors, but the methods described therein are limited to the use of UV-initiated, free-radical-curing systems.

Surprisingly, a method has how been found which makes it possible to produce reactive layers without the afore-mentioned disadvantages and which allows the use of other, non-UV-initiated, free-radical-curing coating systems. The invention relates to a method for forming coatings on an inorganic or organic substrate, wherein

a) a low-temperature plasma, a corona discharge, high-energy radiation and/or a flame treatment is caused to act on the inorganic or organic substrate,

b) 1.) at least one activatable initiator or 2.) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one group that interacts with a subsequently applied coating or reacts with groups contained therein, with the effect of promoting adhesion, and

c) the coated substrate is heated and/or is irradiated with electromagnetic waves and an adhesion promoter layer is formed,

d) the substrate so pretreated is provided with the further coating which contains reactive groups that react with those of the adhesion promoter layer and/or interact with the adhesion promoter layer.

The activatable initiator is preferably a free-radical-forming initiator.

The following advantages of such a method may be mentioned: by means of the described method, reactive layers are formed on a great variety of substrates, which layers also exhibit good adhesion. By the use of ethylenically mono- or poly-unsaturated compounds (monomers, oligomers or polymers) having at least one further reactive group, the properties of the layers produced may be varied within wide limits and a wide range of reactions can be used to anchor the coating to the substrate. The adhesion of the coating can be greatly improved as a result. Controlling the thickness is likewise made simpler and is possible within very wide limits. An advantage of this method is that it can be carried out at normal pressure and does not require complex vacuum apparatus. Excessive thermal stress on the substrates and on the substances used is avoided, so that it is possible to effect targeted introduction of chemical functionalities to obtain the reactive groups. Because conventional application methods can be used, the deposition rates are very high and are virtually unrestricted. Because the substances do not need to be vaporised, it is also possible to use compounds of low volatility or high molecular weight. A large range of compounds is therefore available, and the specific properties required can readily be obtained.

The substrates may be in the form of a powder, a fibre, a woven fabric, a felt, a film or a three-dimensional workpiece. Preferred substrates are synthetic or natural polymers, metal oxides, glass, semi-conductors, quartz or metals, or materials containing such substances. As a semi-conductor substrate, special mention should be made of silicon, which may be, for example, in the form of “wafers”. Metals include especially aluminium, chromium, steel, vanadium, which are used for the production of high-quality mirrors, for example telescope mirrors or vehicle headlamp mirrors. Aluminium is especially preferred.

Examples of natural and synthetic polymers or plastics are listed below.

i) Polymers of mono- and di-olefins, for example polypropylene, polyisobutylene, polybutene-1, poly4-methylpentene-1, polyisoprene or polybutadiene and also polymerisates of cyclo-olefins, for example of cyclopentene or norbornene; and also polyethylene (which may or may not be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE);

ii) mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE);

iii) copolymers of mono- and di-olefins with one another or with other vinyl monomers, for example ethylene/propylene copolymers, linear low density polyethylene (LLDPE) and mixtures thereof with low density polyethylene (LDPE), as well as terpolymers of ethylene with propylene and a diene, such as hexadiene, dicyclopentadiene or ethylidene-norbornene; and also mixtures of such copolymers with one another or with polymers mentioned under i), for example polypropylene-ethylene/propylene copolymers, LDPE-ethylene/vinyl acetate copolymers, LDPE-ethylene/ acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides;

iv) hydrocarbon resins (for example C₅-C₉) including hydrogenated modifications thereof (for example tackifier resins) and mixtures of polyalkylenes and starch;

v) polystyrene, poly(p-methylstyrene), poly(α-methylstyrene);

vi) copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate;

vii) graft copolymers of styrene or α-methylstyrene, for example styrene on polybutadiene, styrene on polybutadiene/styrene or polybutadiene/acrylonitrile copolymers, styrene and acrylonitrile (or methacrylonitrile) on polybutadiene; and mixtures thereof with the copolymers mentioned under vi), such as those known, for example, as so-called ABS, MBS, ASA or AES polymers;

viii) halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate;

ix) polymers derived from α,β-unsaturated acids and derivatives thereof, such as polyacrylates and polymethacrylates, or polymethyl methacrylates, polyacrylamides and polyacrylonitriles impact-resistant-modified with butyl acrylate;

x) copolymers of the monomers mentioned under ix) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers;

xi) polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1;

xii) homo- and co-polymers of cyclic ethers, such as polyalkylene glycols, polyethylene oxide, polypropylene oxide or copolymers thereof with bisglycidyl ethers;

xiii) polyacetals, such as polyoxymethylene, and also those polyoxymethylenes which contain comonomers, for example ethylene oxide; polyacetals modified with thermoplastic polyurethanes, acrylates or with MBS;

xiv) polyphenylene oxides and sulfides and mixtures thereof with styrene polymers or polyamides;

xv) polyurethanes derived from polyethers, polyesters and polybutadienes having terminal hydroxyl groups on the one hand and aliphatic or aromatic polyisocyanates on the other hand, and their initial products;

xvi) polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 1 1, polyamide 12, aromatic polyamides derived from m-xylene, diamine and adipic acid; block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or with ABS; and polyamides condensed during processing (“RIM polyamide systems”);

xvii) polyureas, polyimides, polyamide imides, polyether imides, polyester imides, polyhydantoins and polybenzimidazoles;

xviii) polyesters derived from dicarboxylic acids and dialcohols and/or from hydroxycarboxylic acids or the corresponding lactones, such as polyethylene terephthalate, polybutylene terephthalate, poly-1,4-dimethylolcyclohexane terephthalate, polyhydroxybenzoates, and also block polyether esters derived from polyethers with hydroxyl terminal groups; and also polyesters modified with polycarbonates or with MBS;

xix) polycarbonates and polyester carbonates;

xx) polysulfones, polyether sulfones and polyether ketones;

xxi) crosslinked polymers derived from aldehydes on the one hand and phenols, urea or melamine on the other hand, such as phenol-formaldehyde, urea-formaldehyde and melamine-formaldehyde resins;

xxii) drying and non-drying alkyd resins;

xxiii) unsaturated polyester resins derived from copolyesters of saturated and unsaturated dicarboxylic acids with polyhydric alcohols, and from vinyl compounds as crosslinking agents, and also the halogen-containing, difficultly combustible modifications thereof;

xxiv) crosslinkable acrylic resins derived from substituted acrylic acid esters, e.g. from epoxy acrylates, urethane acrylates or polyester acrylates;

xxv) alkyd resins, polyester resins and acrylate resins that are crosslinked with melamine resins, urea resins, isocyanates, isocyanurates, polyisocyanates or epoxy resins;

xxvi) crosslinked epoxy resins derived from aliphatic, cycloaliphatic, heterocyclic or aromatic glycidyl compounds, e.g. products of diglycidyl ethers of bisphenol A, diglycidyl ethers of bisphenol F, which are crosslinked using customary hardeners, e.g. anhydrides or amines with or without accelerators;

xxvii) natural polymers, such as cellulose, natural rubber, gelatin, or polymer-homologue-chemically modified derivatives thereof, such as cellulose acetates, propionates and butyrates, and the cellulose ethers, such as methyl cellulose; and also colophonium resins and derivatives;

xxviii) mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

In the case of natural polymers, there may be mentioned as being especially preferred carbon fibres, cellulose, starch, cotton, rubber, colophonium, wood, flax, sisal, polypeptides, polyamino acids and derivatives thereof.

The synthetic polymer is preferably a polycarbonate, polyester, halogen-containing polymer, polyacrylate, polyolefin, polyamide, polyurethane, polystyrene and/or polyether.

The synthetic materials can be in the form of films, injection-moulded articles, extruded workpieces, fibres, felts or woven fabrics. In addition to components for the automotive industry, articles such as spectacles or contact lenses may also be provided with a functional layer.

Possible ways of obtaining plasmas under vacuum conditions have been described frequently in the literature. The electrical energy can be coupled in by inductive or capacitive means. It may be direct current or alternating current; the frequency of the alternating current may vary from a few kHz up into the MHz range. A power supply in the microwave range (GHz) is also possible. The principles of plasma generation and maintenance are described, for example, by A. T. Bell, “Fundamentals of Plasma Chemistry” in “Technology and Application of Plasma Chemistry”, edited by J. R. Holahan and A. T. Bell, Wiley, New York (1974) or by H. Suhr, Plasma Chem. Plasma Process 3(1),1, (1983).

As primary plasma gases there may be used, for example, He, argon, xenon, N₂, O₂, H₂, steam or air. The method according to the invention is not per se sensitive with respect to the coupling-in of electrical energy. The method can be carried out in batch operation, for example in a rotating drum, or, in the case of films, fibres or woven fabrics, in continuous operation. Such procedures are known and are described in the prior art.

The method can also be carried out under corona discharge conditions. Corona discharges are generated under normal pressure conditions, the ionised gas most frequently used being air. In principle, however, other gases and mixtures are also possible, as described, for example, in COATING Vol. 2001, No. 12, 426, (2001). The advantage of air as ionising gas in corona discharges is that the procedure can be carried out in apparatus that is open to the outside and that, for example, a film can be drawn through continuously between the discharge electrodes. Such process arrangements are known and are described, for example, in J. Adhesion Sci. Technol. Vol 7, No. 10, 1105, (1993). Three-dimensional workpieces can be treated using a free plasma jet, the contours being followed with the assistance of robots.

The method can be performed within a wide pressure range, the discharge characteristics being shifted, as pressure increases, from a pure low-temperature plasma towards corona discharge and finally, at atmospheric pressure of approximately 1000-1100 mbar, changing into a pure corona discharge.

The method is preferably carried out at a process pressure of from 10⁻⁶ mbar up to atmospheric pressure (1013 mbar), especially at atmospheric pressure in the form of a corona process.

The method is preferably carried out by using, as plasma gas, an inert gas or a mixture of an inert gas with a reactive gas.

Where a corona discharge is used, the gas employed is preferably air, CO₂ and/or nitrogen.

The use of H₂, CO₂, He, Ar, Kr, Xe, N₂, O₂ and H₂O as plasma gases, either singly or in the form of a mixture, is especially preferred.

High-energy radiation, for example in the form of light, UV light, electron beams and ion beams, can likewise be used for activating the surface.

As activatable initiators there come into consideration all compounds or mixtures of compounds that generate one or more free radicals (also in the form of intermediates) when heated and/or irradiated with electromagnetic waves. Such initiators, in addition to including compounds or combinations that are usually thermally activated, such as, for example, peroxides and hydroperoxides (also in combination with accelerators, such as amines and/or cobalt salts) and amino ethers (NOR compounds), also include photochemically activatable compounds (e.g. benzoins) or combinations of chromophores with coinitiators (e.g. benzophenone and tertiary amines) and mixtures thereof. It is also possible to use sensitisers with coinitiators (e.g. thioxanthones with tertiary amines) or with chromophores (e.g. thioxanthones with aminoketones). Redox systems, such as, for example, combinations of H₂O₂ with iron(II) salts, can likewise be used. It is also possible to use electron-transfer pairs, such as, for example, dyes and borates and/or amines. There may be used as initiator a compound or a combination of compounds from the following classes: peroxides, peroxodicarbonates, persulfates, benzpinacols, dibenzyls, disulfides, azo compounds, redox systems, benzoins, benzil ketals, acetophenones, hydroxyalkylphenones, aminoalkylphenones, acylphosphine oxides, acylphosphine sulfides, acyloxyiminoketones, halogenated acetophenones, phenyl glyoxalates, benzophenones, oximes and oxime esters, thioxanthones, camphorquinones, ferrocenes, titanocenes, sulfonium salts, iodonium salts, diazonium salts, onium salts, alkyl borides, borates, triazines, bisimidazoles, polysilanes and dyes, and also corresponding coinitiators and/or sensitisers.

Preferred compounds are: dibenzoyl peroxide, benzoyl peroxide, dicumyl peroxide, cumyl hydroperoxide, diisopropyl peroxydicarbonate, methyl ethyl ketone peroxide, bis(4-tert-butyl-cyclohexyl) peroxydicarbonate, ammonium peroxomonosulfate, ammonium peroxodisulfate, dipotassium persulfate, disodium persulfate, N,N-azobisisobutyronitrile, 2,2′-azobis(2,4-dimethylpentanenitrile), 2,2′-azobis(2-methylpropanenitrile), 2,2′-azobis(2-methylbutanenitrile), 1,1′-azobis(cyanocyclohexane), tert-amyl peroxobenzoate, 2,2′-bis(tert-butylperoxy)-butane, 1,1′-bis(tert-butylperoxy)cyclohexane, 2,5-bis(tert-butylperoxy)-2,5-dimethylhexane, 2,5-bis(tert-butylperoxy)-2,5-dimethyl-3-hexyne, 1,1 -bis(tert-butylperoxy)-3,3,5-trimethylcyclohexane, tert-butyl hydroperoxide, tert-butyl peracetate, tert-butyl peroxide, tert-butyl peroxybenzoate, tert-butyl peroxyisopropyl carbonate, cyclohexanone peroxide, lauroyl peroxide, 2,4-pentanedione peroxide, 2,5-dimethyl-2,5-di(tert-butylperoxy)hexane, di(2-tert-butylperoxyisopropyl)benzene, cobalt octanoate, dicyclopentadienylchromium, peracetic acid, benzpinacol and dibenzyl derivatives, such as dimethyl-2,3-diphenylbutane, 3,4-dimethyl-3,4-diphenylhexane, poly-1,4-diisopropylbenzene, N,N-dimethylcyclohexylammonium dibutyldithiocarbamate, N-tert-butyl-2-benzothioazole sulfenamide, benzothiazyl disulfide and tetrabenzylthiuram disulfide.

Typical examples of photoactivatable systems, which can be used either singly or in mixtures, are mentioned below. For example benzophenones, benzophenone derivatives, acetophenone, acetophenone derivatives, such as, for example, α-hydroxycycloalkyl phenyl ketones or 2-hydroxy-2-methyl-1-phenyl-propanone, dialkoxyacetophenones, α-hydroxy- or α-amino-acetophenones, such as, for example, (4-methylthiobenzoyl)-1-methyl-1-morpholino-ethane, (4-morpholino-benzoyl)-1-benzyl-1-dimethylaminopropane, 4-aroyl-1,3-dioxolanes, benzoin alkyl ethers and benzil ketals, such as, for example, benzil dimethyl ketal, phenyl glyoxalates and derivatives thereof, dimeric phenyl glyoxalates, monoacylphosphine oxides, such as, for example, (2,4,6-trimethylbenzoyl)phenylphosphine oxide, bisacylphosphine oxides, such as, for example, bis(2,6-dimethoxybenzoyl)-(2,4,4-trimethyl-pent-1-yl)-phosphine oxide, bis(2,4,6-trimethylbenzoyl)phenylphosphine oxide or bis(2,4,6-trimethylbenzoyl)-(2,4-dipentyloxyphenyl)phosphine oxide, trisacylphosphine oxides, ferrocenium compounds or titanocenes, such as, for example, (η⁵-2,4-cyclopentadien-1-yl)[1,2,3,4,5,6-η)-(1-methylethyl)benzene]iron(+)-hexafluorophosphate(-1) or dicyclopentadienyl-bis(2,6-difluoro-3-pyrrolophenyl)titanium; sulfonium and iodonium salts, such as, for example, bis[4-(diphenylsulfonio)phenyl]sulfide bishexafluorophosphate, (4-isobutylphenyl)-p-tolyl-iodonium hexafluorophosphate.

As coinitiators there come into consideration, for example, sensitisers that shift or broaden the spectral sensitivity and thus bring about an acceleration of the photopolymerisation. Such sensitisers are especially aromatic carbonyl compounds, for example benzophenone derivatives, thioxanthone derivatives, especially also isopropylthioxanthone, anthraquinone derivatives and 3-acylcoumarin derivatives, triazines, coumarins, terphenyls, styryl ketones, and also 3-(aroylmethylene)-thiazolines, camphorquinone, and also eosin, rhodamine and erythrosine dyes. As coinitiators it is also possible to use tert-amines, thiols, borates, phenylglycines, phosphines and other electron donors.

Preference is given to the use of initiators that contain ethylenically unsaturated groups, because in that way they are incorporated into the polymer chain and thus into the layer during the polymerisation process. Ethylenically unsaturated groups that come into consideration, in addition to vinyl and vinylidene groups, are especially acrylate, methacrylate, allyl and vinyl ether groups.

The ethylenically unsaturated compounds may contain one or more olefinic double bonds. They may be low molecular weight (monomeric) or higher molecular weight (oligomeric, polymeric). By skilful selection it is possible to control the properties of the reactive layers within wide limits.

As reactive groups there come into consideration, for example, aliphatic or aromatic alcohol, thiol, disulfide, aldehyde, ketone, ester, amine, ainide, imide, epoxy, acid, acid anhydride, carboxylic acid, halide, acid halide, nitro, isocyanate and/or cyano functions. It is also possible to use suitably blocked reactive groups (e.g. capped or protected isocyanates) which are deprotected prior to the reaction.

Interactions include ionic and/or dipolar interactions as well as hydrogen bridge bonds and coordinate bonds.

Suitable reactions include all known reactions between the said reactive groups, but especially those which result in the formation of stable bonds. Such reactions include, for example, addition, substitution, condensation, ring-opening, rearrangement, esterification, transesterification, oxidative coupling and/or cross-linking reactions and/or polymerisation reactions and also combinations of parallel or consecutive reactions. The reactions may be accelerated by using suitable catalysts and/or by increasing the temperature. In the case of polymerisation reactions it is possible to use free-radical, ionic, ring-opening, ring-forming, additive and condensation reactions.

Examples of monomers having a double bond are alkyl or hydroxyalkyl acrylates or methacrylates, for example methyl, ethyl, butyl, 2-ethylhexyl or 2-hydroxyethyl acrylate, isobornyl acrylate and methyl or ethyl methacrylate. Also of interest are silicone (meth)acrylates and fluorinated acrylates and methacrylates. Salts or hydrochloride adducts (e.g. the sodium salt of 3-sulfopropyl acrylate, 2-aminoethyl methacrylate hydrochloride) of unsaturated compounds can also be used. Further examples are acrylonitrile, acrylamide, methacrylamide, N-substituted (meth)acrylamides, vinyl esters, such as vinyl acetate, vinyl ethers, such as isobutyl vinyl ether, styrene, alkyl styrenes and halostyrenes, maleic acid or maleic anhydride, N-vinylpyrrolidone, vinyl chloride or vinylidene chloride. There may also be used unsaturated compounds that carry additional groups having an acidic, neutral or basic reaction (e.g. allylamine, 2-aminoethyl methacrylate, 4-vinylpyridine, acrylic acid, 2-propene-1-sulfonic acid). It is also possible to use, for example, the following compounds and their homologues: N-acryloylmorpholine, N-methacryloylmorpholine, 2-N-morpholinoethyl acrylate, morpholinoethyl methacrylate, allylamine, diallylamine, α,α-dimethyl-3-isopropenylbenzylisocyanate, divinyl glycol, glycidyl acrylate, nitrostyrene, propargyl acrylate, propargyl methacrylate, 2-sulfoethyl methacrylate, 3-sulfopropyl methacrylate, 3-sulfopropyl acrylate, tris(2-acryloxyethyl) isocyanurate, n-vinyl caprolactam, vinylbenzoic acid, vinylurea and/oder vinylphenylacetate.

Organometal compounds having unsaturated groups can also be used, for example magnesium acrylate, lead acrylate, tin methacrylate, zinc dimethacrylate, vinylferrocene.

Examples of monomers having more than one double bond are ethylene glycol diacrylate, propylene glycol diacrylate, neopentyl glycol diacrylate, hexamethylene glycol diacrylate and bisphenol A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinylbenzene, divinyl succinate, diallyl phthalate, triallyl phosphate, triallyl isocyanurate, tris-(hydroxyethyl) isocyanurate triacrylate and tris(2-acryloylethyl) isocyanurate.

Examples of higher molecular weight (oligomeric, polymeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. Especially combinations of vinyl-ether-group-carrying oligomers and polymers, such as are described in WO 90/01512, are very suitable, but copolymers of monomers functionalised with maleic acid and vinyl ether also come into consideration. Such unsaturated oligomers can also be referred to as prepolymers.

There are especially suitable, for example, esters of ethylenically unsaturated carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, itaconic acid, cinnamic acid and unsaturated fatty acids such as linolenic acid and oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)-propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or fully esterified by one or by different unsaturated carboxylic acid(s), it being possible for the free hydroxyl groups in partial esters to be modified, for example etherified, or esterified by other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as a component are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N-[(β-hydroxyethoxy)ethyl]-acrylamide.

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene and hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

As mono- or poly-unsaturated olefinic compound there is especially used an acrylate, methacrylate or vinyl ether compound. Polyunsaturated acrylate compounds, such as have already been listed hereinabove, are more especially preferred.

In principle it is advantageous for the solutions, suspensions or emulsions to be applied as quickly as possible, but for many purposes it may also be acceptable to carry out step b) after a time delay. Preferably, however, method step b) is carried out directly after or within 24 hours after method step a).

Application of the solutions, suspensions or emulsions can be carried out in a variety of ways. Application can be effected by immersion, spraying, coating, brush application, knife application, rolling, roller application, printing, spin-coating and pouring.

The concentration of initiators in the liquids to be applied is from 0.01 to 20%, preferably from 0.1 to 5%. The concentration of ethylenically unsaturated compounds in those liquids is from 0.1 to 30%, preferably from 0.1 to 10%.

The liquids may additionally comprise other substances, for example defoamers, emulsifiers, surfactants, anti-fouling agents, wetting agents and other additives customarily used in the coatings and paints industry.

The thickness of the applied layer in the dry state is likewise matched to the requirements of the later use and ranges from a monomolecular layer up to 2 mm, especially from 2 nm to 1000 μm, more especially from 2 nm to 1000 nm.

In principle it is advantageous for the melts, solutions, suspensions or emulsions to be heated, dried or irradiated as rapidly as possible, since the layer is fixed and stabilised by means of that step, but it may also be acceptable for many purposes for step c) to be carried out after a time delay. Preferably, however, method step c) is carried out directly after or within 24 hours after method step b).

Many possible methods of heating/drying coatings are known and they can all be used in the claimed method. Thus, for example, it is possible to use hot gases, IR radiators, ovens, heated rollers and microwaves. The temperatures used for that purpose are governed by the thermal stability of the materials used and generally range from 0 to 300° C.; preferably, they are from 0 to 200° C.

In the case of particularly temperature-sensitive materials, irradiation with electromagnetic waves may be advantageous. Care must be taken that the initiator used is one which absorbs also in the wavelength ranges in which the UV absorber exhibits no or only little absorption. Irradiation of the coating can be carried out using any source that emits electromagnetic waves of wavelengths that can be absorbed by the photoinitiators employed. Such sources are generally those which emit electromagnetic radiation of wavelengths in the range from 200 nm to 2000 nm. In addition to customary radiators and lamps, it is also possible to use lasers and LEDs (Light Emitting Diodes). The whole area or parts thereof can be irradiated. Partial irradiation is of advantage when only certain regions are to be rendered adherent. Irradiation can also be carried out using electron beams. The whole area and/or parts thereof can be irradiated, for example, by means of irradiation through a mask or using laser beams. By that means it is possible to achieve fixing and stabilisation of the coating in certain regions only. In unexposed regions, the layer could be washed off again and in that manner structuring achieved.

The heating/drying and/or irradiation can be carried out in air or under inert gas. Nitrogen gas comes into consideration as the inert gas, but other inert gases, such as CO₂ and argon, helium etc. or mixtures thereof, can also be used. Suitable equipment and apparatus will be known to the person skilled in the art and are commercially available.

Coating of the pretreated substrate can be effected by any known coating method, for example by electrophoretic deposition, vapour deposition, immersion, spraying, coating, brush application, knife application, rolling, roller application, printing, spin-coating and pouring. The application of the coating to the pretreated substrates can be effected immediately after step c), but very much longer intervals of days, months or years are also possible.

The coatings to be applied can be organic and/or inorganic materials. Organic layers can be, for example, resist materials, protective layers, paints, colorants, release layers, printing inks and/or adhesives that are applied in liquid form (including in molten form) and converted into a solid form by suitable drying and/or hardening conditions, it being advantageous for the reactions taking place during drying and/or hardening also to include the reactive groups present on the surface. When, for example, epoxy groups (for example resulting from the use of glycidiyl methacrylate) are anchored to the substrate surface, it is possible to react in coatings that allow an acid- or base-catalysed ring-opening reaction. Special mention may be made here of cationically polymerisable formulations of epoxides and/or vinyl ethers that are initiated by photochemically and/or thermally activatable acid generators. In those cases, improved adhesion of the coating to the surfaces can be obtained also when those surfaces have been provided beforehand with OH groups, which can be achieved by the use of OH-functionalised initiators and/or unsaturated compounds in step b). Anchored epoxy groups can, however, also be reacted with amines and/or alcohols and/or phenols to form stable bonds.

Groups anchored to the substrate surface, especially those having a reactive hydrogen atom (e.g. OH, NH, SH etc), can be reacted with a series of other reactive groups, such as are used in many adhesives, paints and coatings. In addition to epoxy groups, such reactive groups include acids, acid chlorides, carboxylic acids, acid anhydrides, isocyanates, organosiloxanes having SiOR and/or SiOX groups (X=halogen). OH groups may also give rise to increased adhesion, however, in the case of physically drying systems, for example polyvinyl acetate adhesives, polyester adhesives, polyacrylic acid ester adhesives.

Oxidatively crosslinking coating systems can be rendered adherent by using as ethylenically unsaturated compounds those compounds having further double or triple bonds, for example propargyl acrylate, propargyl methacrylate, dicyclopentenyloxyethyl acrylate or dicyclopentenyl methacrylate.

Thiol/ene reactions can likewise be utilised, for example by anchoring thiol groups (e.g. with the aid of ethylthioethyl methacrylate, thiol-diethylene glycol diacrylate, 2-(methylthio)ethyl methacrylate and methyl-2-methyl thioacrylate) to the surface and allowing them to react with unsaturated bonds in the coating. The reverse route by way of anchored, but unreacted unsaturated bonds with thiols in the coating is likewise possible. Anchored thio groups can also be utilised for improving the adhesion of metals, especially gold.

It is also possible for solid and/or web-form materials to be brought into contact with one another and for an interaction and/or reaction of the reactive groups present on the interfaces to take place. For example, sheets, films and/or woven fabrics can be applied to one another by lamination, the reactive groups (e.g. —COOH on the pretreated side and OH— on the other side) for example creating a strongly adherent bond as result of esterification. Powder coatings can also be applied and anchored.

The inorganic layers can be, for example, ceramic or metallic materials that are applied either by vapour deposition or sputtering or by film/foil lamination and react and/or interact with the reactive groups on the pretreated surface. For example, by the use of acrylated amino compounds and/or morpholines in step b) it is possible generate amino functions which form complexes with vapour-deposited copper and result in increased adhesion of the copper. OH-functional solids (e.g. SiOₓ layers) can be reacted analogously with halogen groups that have been anchored to the substrate surface by way of suitable halogenated ethylenically unsaturated compounds (e.g. 2-bromoethyl acrylate).

Table 1 below shows some further examples of interactions and reactions that result in a bond between the applied coating and the adhesion promoter layer.

TABLE 1
Examples of interactions and reactions that result
in a bond between the applied coating and the
adhesion promoter layer (not complete)

| Functionality 1 | Functionality 2 | Interaction |
|---|---|---|
| Dipoles | Dipoles | Dipolar |
| (—OH, C═O) | (—OH, C═O) | interaction |
| —OH, >NH, —SH, | >C═O, NR₃, | Hydrogen |
| | | bridges |
| Ionic groups (COO⁻, | Ionic groups (COO⁻, | Ionic |
| —NR₃⁺, —SO₃⁻, | —NR₃⁺, —SO₃⁻, | interactions |
| —O—PO₃²⁻) | —O—PO₃²⁻) | |
| —NH₂, COOH, —SH, | Metals, Cu, Fe, Au, | Coordinate |
| amides, phosphoric acid | | bonds |
| esters, morpholines, | | |
| chelates, aromatic amino | | |
| compounds, imidazoles | | |

| Functionality 1 | Functionality 2 | Reaction |
|---|---|---|
| Carboxylic acid, acid | Carboxylic acid, acid | (Poly)conden- |
| halide, alcohols, | halide, alcohols, | sation |
| amines, esters, acid | amines, esters, acid | |
| anhydrides, aldehydes | anhydrides, aldehydes | |
| Isocyanates, amines, | Isocyanates, amines, | (Poly)addition |
| epoxides, alcohols | epoxides, alcohols | |
| Epoxides, vinyl | Epoxides, vinyl | Cationic |
| ethers, oxiranes | ethers, oxiranes | polymerisation |
| Ethylenically | Ethylenically | Free-radical |
| unsaturated bonds | unsaturated bonds | polymerisation |
| (acrylate, vinyl ether) | (acrylate, vinyl ether) | |
| Lactones, lactams, | Lactones, lactams, | Ring-opening |
| | | polymerisation |
| Thiols | Ethylenically | Thiol/ene |
| | unsaturated | reaction |
| Ethylenically | Ethylenically | Oxidative |
| unsaturated bonds | unsaturated bonds | coupling |

The functionalities 1 and 2 can in each case be located in the adhesion promoter layer and/or the coating.

Also claimed are coatings produced in accordance with one of the methods described above.

Also claimed are products that have been provided with a coating in accordance with one of the preceding claims.

The Examples which follow illustrate the invention.

### EXAMPLE 1

A white polyvinyl chloride sheet (2 mm) is corona-treated in air four times using a ceramic electrode (manual corona station type CEE 42-0-1 MD, width 330 mm, SOFTAL) at a distance of about 1-2 mm and at an output of 400 W and a treatment rate of 10 cm/s. An ethanolic solution containing 0.3% initiator of the following structural formula

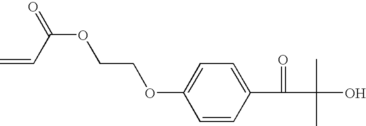

and 0.7% 2-hydroxyethyl methacrylate (Fluka) is applied to the treated side of the film using a 4 μm knife (Erichsen). The specimens are stored briefly until the alcohol has evaporated and the specimens are dry. The specimens are then irradiated using a UV processor (Fusion Systems) having a microwave-excited mercury lamp and an output of 120 W/cm at a belt speed of 30 m/min. An aqueous adhesive based on polyvinyl acetate, polyvinyl alcohol and starch (Ponal express, Henkel) is then applied in a layer thickness of about 0.5 mm, and a piece of silk (2×8cm) is gently applied to the adhesive mass by rolling. The resulting specimens are then dried overnight. The adhesive strength is tested by tearing off the silk. On the untreated PVC sheet, the adhesive does not adhere. On the treated PVC sheet, a cohesive fracture of the adhesive occurs and and an unbroken layer of adhesive material remains on the PVC sheet.

### EXAMPLE 2

A 50 μm thick biaxally oriented polypropylene film is corona-treated in air four times using a ceramic electrode (manual corona station type CEE 42-0-1 MD, width 330 mm, SOFTAL) at a distance of about 1-2 mm and at an output of 400 W and a treatment rate of 10 cm/s. An ethanolic solution containing 1% initiator of the following structural formula

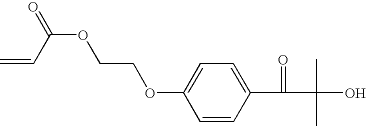

is applied to the treated side of the film using a 4 μm knife (Erichsen). The specimens are stored briefly until the alcohol has evaporated and the specimens are dry. The specimens are then irradiated using a UV processor (Fusion Systems) having a microwave-excited mercury lamp and an output of 120 W/cm at a belt speed of 15 m/min. An aqueous adhesive based on polyvinyl acetate, polyvinyl alcohol and starch (Ponal express, Henkel) is then applied in a layer thickness of about 60 μm, and a 15 mm wide strip of silk is pressed evenly into the adhesive mass using a pressing roller. The resulting specimens are then dried overnight. The adhesive strength is tested in a tensile test. No adhesion is obtained on the untreated film, but on the treated film an adhesive strength of 8.9 N per 15 mm is obtained.

### EXAMPLE 3

A 40 μm thick HDPE film web is treated by means of a corona station (Vetaphone Corona Plus) at an output of 200 W and, using a three-roller application device, is coated with an aqueous 1% solution of the initiator of the following structural formula

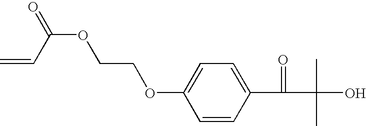

The speed of the web is 30 m/min. Drying is effected using air at a temperature of 60° C. which is blown onto the moving film over a length of 1 m. Irradiation is then carried out using a UV lamp (IST Metz M200 U1, 60 W/cm). To the film so pretreated there is then applied at a web speed of 10 m/min, using a three-roller application device, a formulation consisting of 98 parts of epoxy-functionalised polydimethylsiloxane copolymer (UV 9300, GE Bayer Silicones) and 2 parts of iodonium salt initiator of the following structural formula

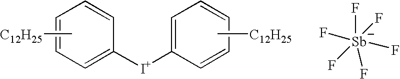

45% in glycidyl ether (UV9380 C, GE Bayer Silicones) in an amount of about 1 g/m² and irradiation is carried out using a UV lamp (IST Metz M200 U1, 60 W/cm).

The adhesion of the applied layer is determined by rubbing. In the case of untreated films, the silicone layer can easily be rubbed off, but in the case of films coated with initiator the silicone layer cannot be removed at all. The adhesion does not change even after storage at room temperature for a period of two weeks.

### EXAMPLE 4

A 36 μm thick PETP film web is treated by means of a corona station (Vetaphone Corona Plus) at an output of 200 W and, using a three-roller application device, is coated with an aqueous 1% solution of the initiator of the following structural formula

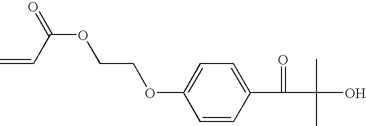

The speed of the web is 30 m/min. Drying is effected using air at a temperature of 60° C. which is blown onto the moving film over a length of 1 m. Irradiation is then carried out using a UV lamp (IST Metz M200 U1, 60 W/cm). To the film so pretreated there is then applied at a web speed of 10 m/min, using a three-roller application device, a formulation consisting of 98 parts of epoxy-functionalised polydimethylsiloxane copolymer (UV 9300, GE Bayer Silicones) and 2 parts of iodonium salt initiator of the following structural formula

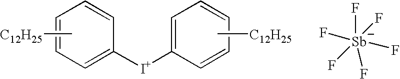

45% in glycidyl ether (UV9380 C, GE Bayer Silicones) in an amount of about 1 g/m² and irradiation is carried out using a UV lamp ([ST Metz M200 U1, 60 W/cm).

The adhesion of the applied layer is determined by rubbing. In the case of untreated films, the silicone layer can easily be rubbed off, but in the case of films coated with initiator the silicone layer cannot be removed at all. The adhesion does not change even after storage at room temperature for a period of two weeks.

1. A method for forming a coating on an inorganic or organic substrate, wherein
a) a low-temperature plasma, a corona discharge, high-energy radiation and/or a flame treatment is caused to act on the inorganic or organic substrate,
b) 1.) at least one activatable initiator or 2.) at least one activatable initiator and at least one ethylenically unsaturated compound is/are applied in the form of a melt, solution, suspension or emulsion to the inorganic or organic substrate, there being incorporated in the activatable initiator and/or the ethylenically unsaturated compound at least one group that interacts with a subsequently applied coating or reacts with groups contained therein, with the effect of promoting adhesion, and
c) the coated substrate is heated and/or is irradiated with electromagnetic waves and an adhesion promoter, layer is formed,
d) the substrate so pretreated is provided with a further coating which contains reactive groups that react with those of the adhesion promoter layer and/or interact with the adhesion promoter layer.

2. A method according to claim 1, wherein the inorganic or organic substrate is in the form of a powder, a fibre, a woven fabric, a felt, a film or a three-dimensional workpiece.

3. A method according to claim 1, wherein the organic substrate is or comprises a synthetic or natural polymer, a metal oxide, a glass, a semi-conductor, quartz or a metal.

4. A method according to claim 1, wherein the organic substrate is or comprises a homopolymer, block polymer, graft polymer and/or copolymer and/or a mixture thereof.

5. A method according to claim 1, wherein the organic substrate is or comprises a polycarbonate, polyester, halogen-containing polymer, polyacrylate, polyolefin, polyamide, polyurethane, polystyrene, polyaramide and/or polyether.

6. A method according to claim 1, wherein the initiator is a compound or combination of compounds from the classes of the peroxides, peroxodicarbonates, persulfates, benzpinacols, dibenzyls, disulfides, azo compounds, redox systems, benzoins, benzil ketals, acetophenones, hydroxyalkylphenones, aminoalkylphenones, acylphosphine oxides, acylphosphine sulfides, acyloxyiminoketones, peroxy compounds, halogenated acetophenones, phenyl glyoxylates, benzophenones, oximes and oxime esters, thioxanthones, ferrocenes, titanocenes, sulfonium salts, iodonium salts, diazonium salts, onium salts, borates, triazines, bisimidazoles, polysilanes and dyes, and also corresponding coinitiators and/or sensitisers.

7. A method according to claim 1, wherein the initiator has at least one ethylenically unsaturated group, especially a vinyl, vinylidene, acrylate, methacrylate, allyl or vinyl ether group.

8. A method according to claim 1, wherein the ethylenically unsaturated compound is used in the form of a monomer, oligomer and/or polymer.

9. A method according to claim 1, wherein the ethylenically unsaturated compound is a mono-, di-, tri-, tetra- or poly-functional acrylate, methacrylate or vinyl ether.

10. A method according to claim 1, wherein the low-temperature plasma is run in a gas and the gas is air, water, reactive gas, inert gas, or a mixture thereof.

11. A method according to claim 1, wherein method step b) is carried out by immersion, spraying, coating, brush application, knife application, rolling, roller application, spin-coating, printing or pouring.

12. A method according to claim 1, wherein the melt, solution, suspension or emulsion used in method step b) contains the initiator(s) in a concentration of from 0.01 to 20%.

13. A method according to claim 1, wherein the melt, solution, suspension or emulsion used in method step b) contains the unsaturated compound(s) in a concentration of from 0.1 to 30%.

14. A method according to claim 1, wherein the melt, solution, suspension or emulsion used in method step b) may additionally comprise other substances chosen from defoamers, emulsifiers, surfactants, anti-fouling agents, wetting agents and other additives customarily used in the coatings industry.

15. A method according to claim 1, wherein the thickness of the applied layer in the dry state ranges from a monomolecular layer up to 2 mm.

16. A method according to claim 1, wherein in method step c) irradiation is carried out using sources which emit electromagnetic waves of wavelengths in the range from 200 nm to 20 000 nm or by means of electron beams, optionally preceded by a drying step.

17. A method according to claim 1, wherein in method step c) irradiation is effected over the whole area or parts thereof.

18. A method according to claim 1, wherein in method step c) partial irradiation is effected and unexposed material is then removed.

19. A method according to claim 1, wherein method step d) is carried out by immersion, spraying, coating, brush application, knife application, rolling, roller application, spin-coating, printing, pouring, lamination, vapour deposition, sputtering or bringing into contact.

20. A method according to claim 1, wherein the coating applied in method step d) are organic and/or inorganic materials.

21. A method according to claim 1, wherein the coating applied in method step d) are solid or liquid materials.

22. A method according to claim 1, wherein the coating applied in method step d) are resist materials, paints, colorants, release layers, protective layers, printing inks, adhesives and/or films, woven fabrics, fibres, metallic layers.

23. A substrate having a reactive layer, obtainable by a method according to claim 1.
